(19) United States
(12) Patent Application Publication
(10) Pub. No.: US 2006/0234712 A1
(43) Pub. Date: Oct. 19, 2006

(54) Routing wireless communications

(76) Inventors: Kevin Fallis, Overland Park, KS (US); Dan O'Bryan, Kansas City, MO (US); Lang Zhang, Cornwall (CA); Chris Blackburn, Overland Park, KS (US)

Correspondence Address: MACPHERSON KWOK CHEN & HEID LLP, 1762 TECHNOLOGY DRIVE, SUITE 226, SAN JOSE, CA, 95110, US

(21) Appl. No.: 11/106,117

(22) Filed: Apr. 13, 2005

(51) Int. Cl. H04M 1/66

(52) U.S. Cl. 455/445; 455/410

(57) ABSTRACT

A method for routing wireless communications by a host system comprises receiving from a wireless communication device(CD) of a wireless subscriber(WS) a valid routing request data; authenticating WS's account information as valid subscriber account based on predetermined authentication criteria, and if account information is valid, receiving from wireless CD a destination telephone number(DTN) of a destination CD, resolving the valid routing request data to a predetermined wire-based medium; and establishing communication between subscriber's CD and destination CD via predetermined wire-based medium based on DTN. Another method comprises receiving from a user's CD a valid routing request data and a DTN of a wireless CD of WS; authenticating WS's account as valid based on received DTN and predetermined authentication criteria; and if WS's account is valid, resolving valid routing request data to a predetermined wire-based medium; and establishing communication between user's CD and subscriber's CD via predetermined wire-based medium.

### RELATED APPLICATIONS

This application is related to the co-filed patent application entitled “FACILITATING ROUTING REQUESTS RECEIVED IN WIRELESS COMMUNICATION DEVICES”, filed on Apr. 13, 2005 as U.S. Ser. No. [M-15811 US], the details of which are herein incorporated by reference.

### FIELD OF THE INVENTION

This invention relates to wireless communications. More particularly, the present invention is directed to a routing device for wireless communications.

### BACKGROUND OF THE INVENTION

Wireless communication devices such as cell phones and personal digital assistants (PDA) are becoming increasingly widespread in use. Wireless communication offers the convenience and flexibility of allowing a user to become mobile while remaining accessible for communication with others so long as the user remains within a wireless zone of coverage.

Generally, a wireless device such as a cell phone communicates with a base-station administering the calls in the cell. The base station typically receives a calling request by a user such as via a telephone number of a destination device that is input by the user via a phone pad or voice recognition device. The base-station then routes the call through secondary stations until a routing link is established with the destination device. The call is then established between the user and the destination device based on the routing link.

While in widespread use today, the foregoing routing approach is not without shortcomings. One such short coming is that once a telephone number is input by a user, the user is not allowed to select which routing link the requested call is to take in reaching the destination device. Since the links through which a call is routed are often owned by different service providers who may charge different rates based on the the selected links. For example, for international calls, utilizing intermediary land-based links such as sub-oceanic copper or fiber-optic wires often results in substantial savings to the user over wireless links such as satellite. Unfortunately, the user is not provided with a choice as to which medium to have his or her calls routed through and thus may have to unwillingly bear the higher cost of a satellite intermediary link when placing calls. This scenario also occurs when a user receives a long distance call from a caller for which the user is often charged with the difference in fees between the caller's charges and the user's higher wireless charges.

Accordingly, there is a need in the art for providing a wireless user with an ability to select a desired cost-efficient link for routing of the wireless calls made or received by the user.

### SUMMARY

At least one aspect of the invention can be regarded as a method for routing wireless communications by a host system. The method comprises receiving from a wireless communication device of a wireless subscriber valid routing request data; authenticating a wireless subscriber's account information as a valid subscriber account based on predetermined authentication criteria, and if the account information is valid, receiving from the wireless communication device a destination telephone number of a destination communication device; resolving the valid routing request data to a predetermined wire-based medium; and establishing communication between the subscriber's wireless communication device and the destination communication device via the predetermined wire-based medium based on the destination telephone number.

At least one aspect of the invention can also be regarded as a method for routing communications by a host system to a wireless subscriber. The method comprises receiving from a user's communication device a valid routing request data and a destination telephone number of a wireless communication device of a wireless subscriber; authenticating a wireless subscriber's account as a valid subscriber's account based on the received destination telephone number and predetermined authentication criteria; and if the wireless subscriber's account is valid, resolving the valid routing request data to a predetermined wire-based medium; and establishing communication between the user's communication device and the subscriber's wireless communication device via the predetermined wire-based medium based on the destination telephone number.

At least one aspect of the invention can also be regarded as a method for establishing conference call communication between a wireless subscriber and a plurality of users' communication devices. The method comprises receiving from a wireless communication device of a wireless subscriber a valid routing request data for establishing conference call communication; authenticating a wireless subscriber's account information as a valid subscriber account based on predetermined authentication criteria, and if the account information is valid, resolving the valid routing request data to a predetermined wire-based conference bridge; receiving from each of the plurality of users' communication devices an access request data for accessing the wireless subscriber's conference bridge; authenticating each user's access request data, and if the access request data is valid, establishing for each authenticated user the conference call communication between each users' communication device and the wireless communication device of the wireless subscriber via the predetermined conference bridge.

At least one aspect of the invention can also be regarded as a method for routing communications by a recipient host system to a wireless subscriber. The method comprises receiving from a wireless communication device of a wireless subscriber a valid routing request data, and authenticating a wireless subscriber's account information as a valid subscriber account based on predetermined authentication criteria, and if the account information is valid, determining if the wireless subscriber is local to the recipient host system based on predetermined locating criteria, and if the wireless subscriber is not local to the recipient host system initiating a forwarding of calls intended for the wireless subscriber from a host system local to the wireless subscriber to the recipient host system wherein the forwarded calls are re-routed via a predetermined wire-based medium.

At least one aspect of the invention can also be regarded as a host system for routing wireless communications. The host system comprises a receiver subsystem in communication with a wireless communication device of a wireless subscriber and adapted to receive from the wireless communication device a valid routing request data and a destination telephone number of a destination communication device; an authentication subsystem adapted to authenticate a wireless subscriber's account information as a valid subscriber account based on predetermined authentication criteria; a resolution subsystem adapted to resolve the valid routing request data to a predetermined wire-based medium if the account information is valid; and a routing application residing in the host system and adapted to establish communication between the subscriber's wireless communication device and the destination communication device via the predetermined wire-based medium based on the destination telephone number.

### BRIEF DESCRIPTION OF THE DRAWINGS

FIG. 1 illustrates an exemplary communication system in which the method of the present invention may be practiced.

FIG. 2 is a flow diagram illustrating a method according to an embodiment of the present invention.

FIGS. 3A-C are flow diagrams further illustrating the method of FIG. 2.

FIG. 4 is a flow diagram illustrating a method according to another embodiment of the present invention.

FIGS. 5A-C are flow diagrams further illustrating the method of FIG. 4.

FIG. 6 is a flow diagram illustrating a method according to yet another embodiment of the present invention.

FIG. 7 is a flow diagram illustrating a method according to yet another embodiment of the present invention.

FIGS. 8-9 illustrate in greater detail aspects of the exemplary communication system shown in FIG. 1.

FIGS. 10A-N are sequence diagrams illustrating in greater detail aspects of the exemplary communication system shown in FIG. 1.

### DETAILED DESCRIPTION OF THE INVENTION

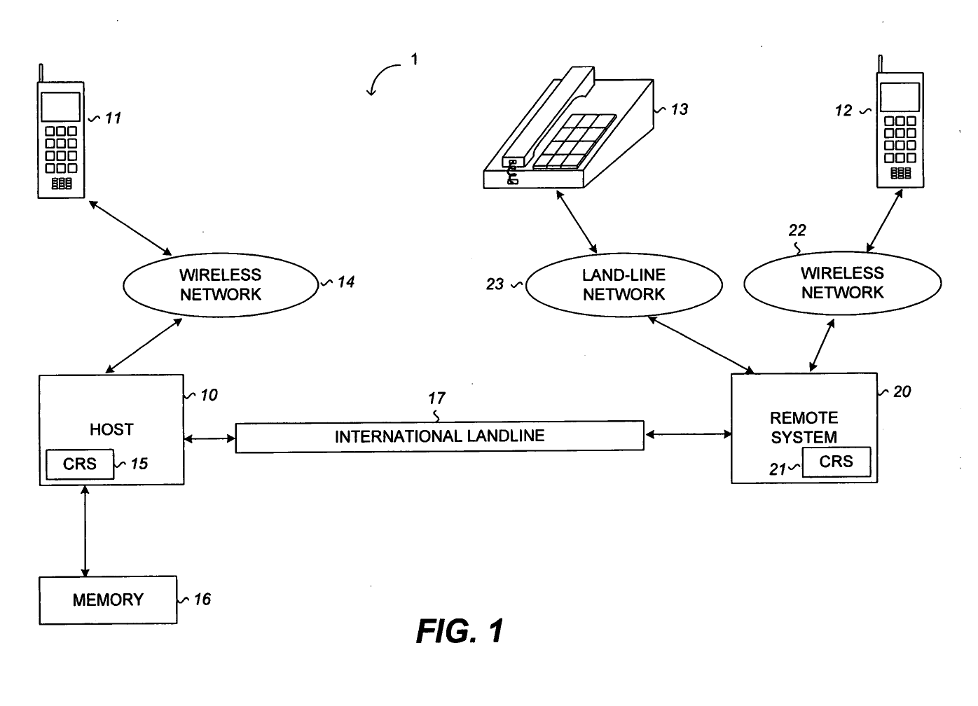

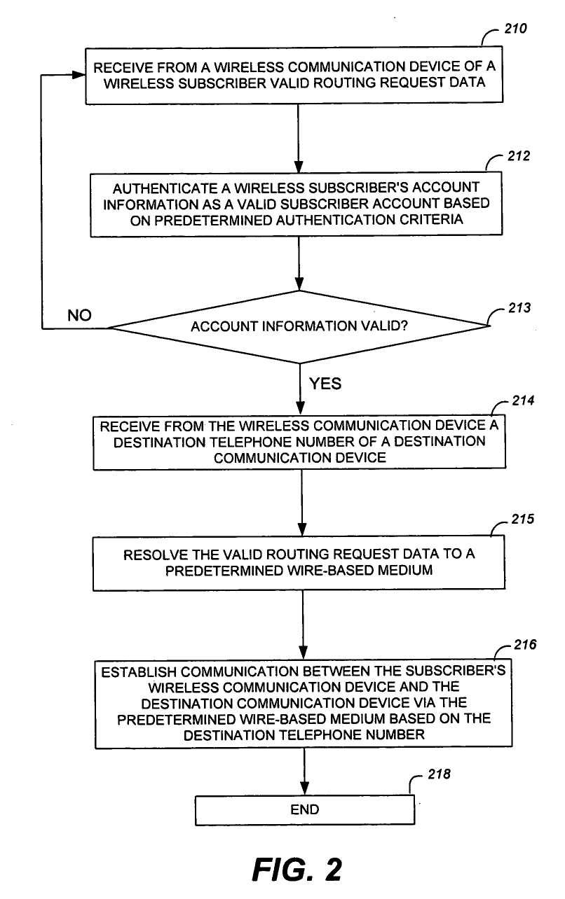

With reference to FIG. 1, an exemplary communication system 1 in which the methods of the present invention maybe practiced is shown. One embodiment of the present invention is the method for routing wireless communications by a host system 10 as illustrated via the flow diagram in FIG. 2 and in conjunction with FIG. 1. As shown in FIG. 2, the process begins in block 210 in which a user-input valid routing request data is received in the host system 10 across a wireless network 14 from a wireless communication device 11 such as a wireless phone of a subscriber. In an exemplary embodiment, valid routing request data comprises a string of characters and/or numeric data having a predetermined format that is recognizable by the host system 10 as a request to route the incoming wireless call to a land-based line, as described in greater detail below. In an exemplary embodiment, the host system 10 is host to a call routing system (CRS) application 15 that is adapted to recognize the valid routing request data based on its predetermined format. In an exemplary embodiment, the valid routing request data is received from a Subscriber's Interface Module (SIM) installed on the user's wireless communication device, such as that described in the above referenced patent application.

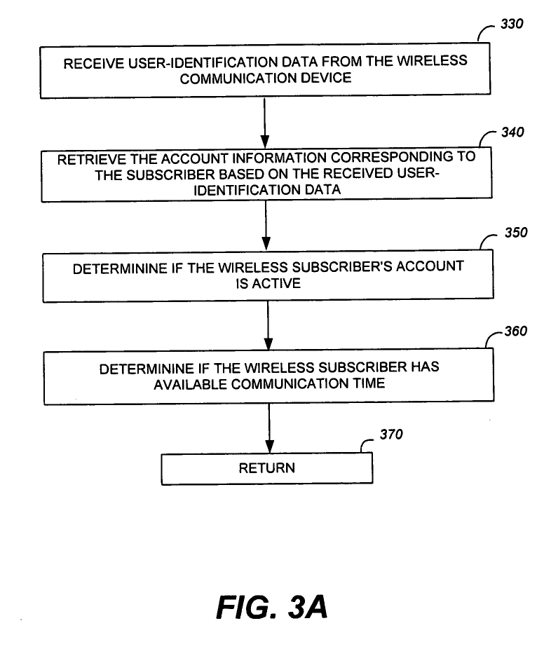

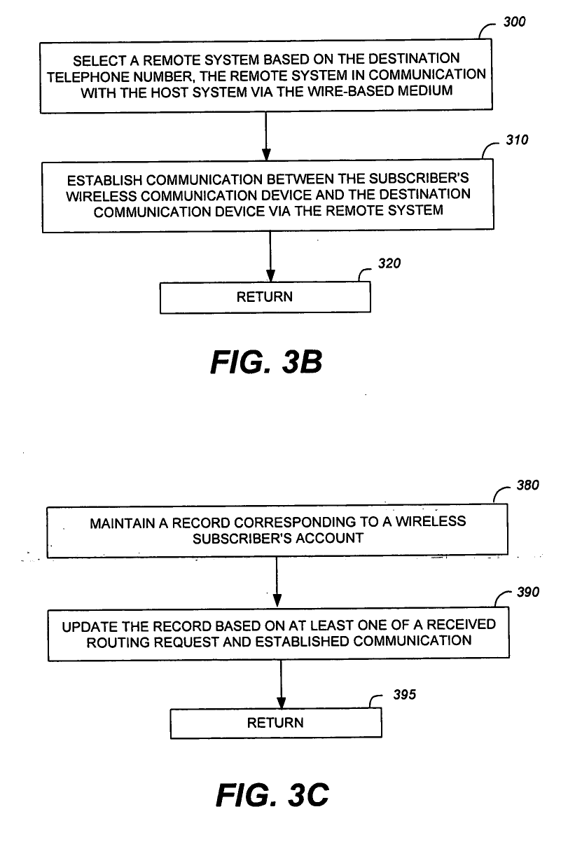

Next, in block 212, the wireless subscriber's account information is authenticated by the host system 10 based on predetermined authentication criteria as described below and in greater detail in conjunction with FIG. 3A. Next, in decision block 213, if it is determined that the wireless subscriber's account is invalid, the process returns to block 212 for receipt of further data. In an exemplary embodiment, the user is notified of the invalid status of the wireless subscriber's account and prompted to re-enter a valid account. If in decision block 213 it is determined that the wireless subscriber's account is valid, then the flow proceeds to block 214 in which a destination telephone number of a destination communication device, such as wireless communication device 12 or wireless communication device 13 is received from the wireless communication device 11. Next, in block 215, a valid routing request data is resolved via the CRS application 15 to a predetermined wire-based medium 17, such as the international direct dialing land-line. Next, in block 216, communication is established between the subscriber's wireless communication device 11 and the destination communication device 12 or 13 based on the destination telephone number via the predetermined wire-based medium 17, as described below and in greater detail in conjunction with FIG. 3B. The flow then proceeds to block 218 in which the overall process ends. In an exemplary embodiment, at least one of the wireless communication devices 11 or 12 is a Global System for Mobile communication (GSM) device.

FIG. 3A further illustrates the authenticating process described in block 212 of FIG. 2. As shown in FIG. 3A, the process begins in block 330 in which a user-identification data is received from the wireless communication device 11. In an exemplary embodiment, the user-identification data comprises a caller-identification data and/or an equipment-identification data. Next, in block 340, the account information corresponding to the subscriber is retrieved based on the received user-identification data. In an exemplary embodiment, the host system 10 is in communication with a memory subsystem 16 from which the wireless subscriber's account information can be retrieved. Next, in block 350, the wireless subscriber's account is checked against a predetermined authentication criteria of determining if the wireless subscriber's account is active. In an exemplary embodiment, a predetermined flag is used to if the wireless subscriber's account is inactive, such as due to non-payment or user's request. Next, in block 360, the wireless subscriber's account is checked against another predetermined authentication criteria of determining if the wireless subscriber has available communication time, such as available air-time minutes. The flow then proceeds to block 370 for returning to block 212 of FIG. 2.

FIG. 3B further illustrates the process described in block 216 of FIG. 2. As shown in FIG. 3B, the process begins in block 300 in which a remote host system 20 is selected based on the destination telephone number wherein the remote host system 20 in communication with the host system 10 via the wire-based medium 17. In an exemplary embodiment, the remote host system 20 is host to a remote call routing system (CRS) application 21 which functions to communicate with the CRS application 15 to establish the communication between the host system 10 and remote host system 20 via the wire-based medium 17. Next, in block 310, the communication between the subscriber's wireless communication device 11 and the destination communication devices 12 or 13 is established based on the destination telephone number via the remote host system 20, such as by routing the call through wireless network 22 or land-line network 23, respectively. The flow then proceeds to block 320 for returning to block 216 of FIG. 2.

FIG. 3C further illustrates the process described in block 216 of FIG. 2. As shown in FIG. 3C the process begins in block 380 in which a record corresponding to a wireless subscriber's account is maintained, such as a log file of user's activities. Next, in block 390, the record is updated based on the received routing request and established communication to reflect wireless subscriber's current call. The flow then proceeds to block 395 for returning to block 216 of FIG. 2.

One advantage of the foregoing feature of the present invention over the prior art is that by allowing a wireless subscriber to select a wire-based medium to route the wireless calls through, a wireless subscriber is provided with an ability to select a desired cost-efficient link for routing of the wireless calls made by the wireless subscriber.

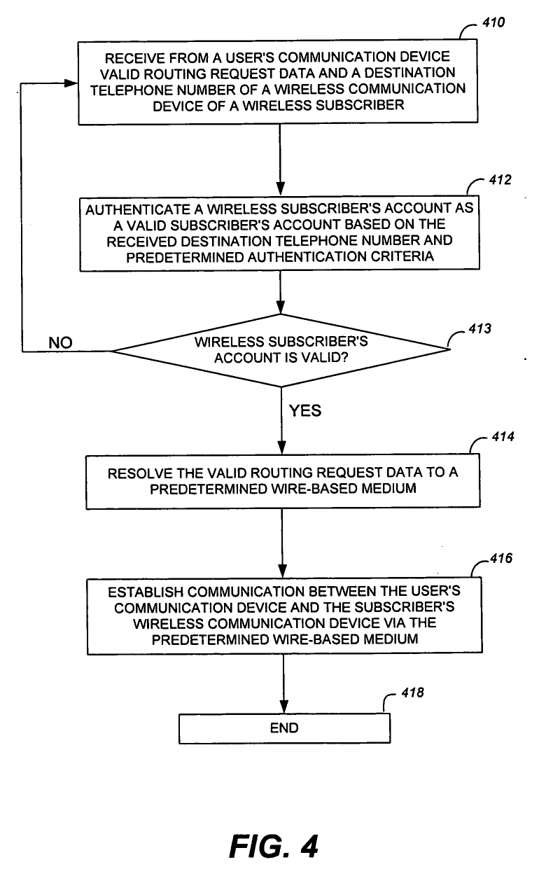

Another embodiment of the present invention is the method for routing communications by a remote host system 20 to a wireless subscriber, as illustrated via the flow diagram in FIG. 4 and in conjunction with FIG. 1. As shown in FIG. 4, the process begins in block 410 in which user-input valid routing request data and a destination telephone number of a wireless communication device 11 of a wireless subscriber is received from a user's communication device, such as from wire-based phone 13 or wireless phone 12, in the remote host system 20 across a land-line network 23 or wireless network 22, respectively. In an exemplary embodiment, a valid routing request data comprises a data string of characters and/or numeric data having a predetermined format, such as * 888, that is recognizable by the remote host system 20 as a request to route the incoming call to a land-based line, as described in greater detail below. In an exemplary embodiment, the remote host system 20 is host to the remote CRS application 21 that is adapted to recognize the valid routing request data based on its predetermined format.

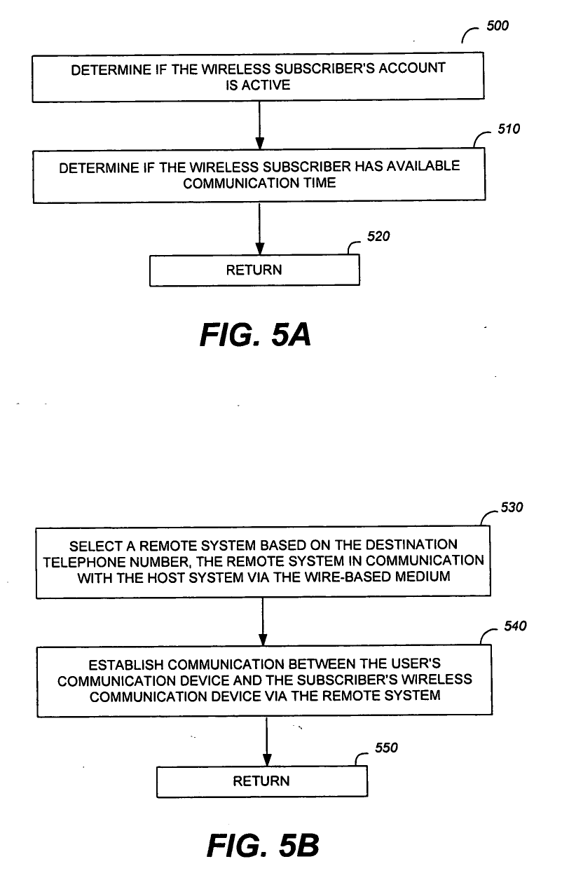

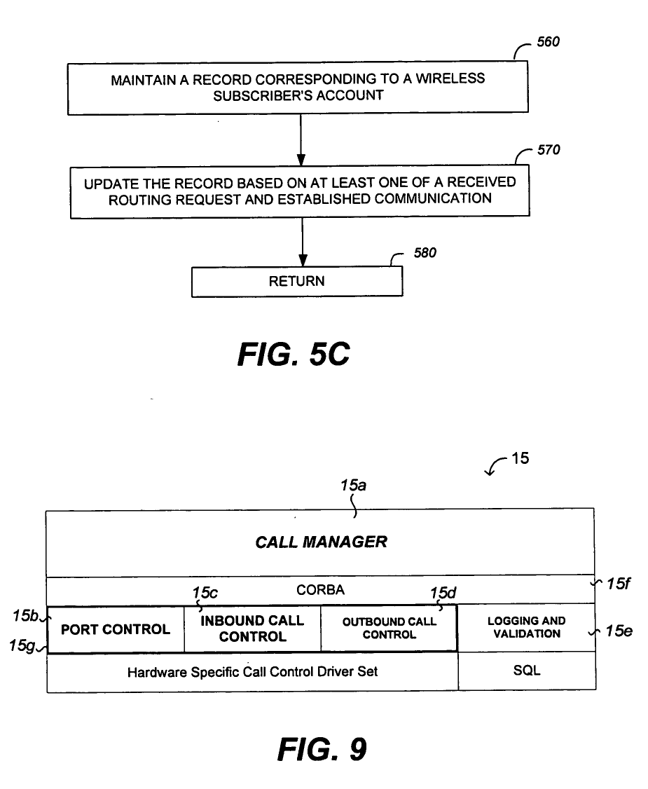

Next, in block 412, the wireless subscriber's account information is authenticated by the remote host system 20 based on predetermined authentication criteria as described below and in greater detail in conjunction with FIG. 5A. Next, in decision block 413, if it is determined that the wireless subscriber's account is invalid, the process returns to block 412 for receipt of further data. In an exemplary embodiment, the user is notified of the invalid status of the wireless subscriber's account and prompted to re-enter a valid account. If in decision block 413 it is determined that the wireless subscriber's account is valid, then the flow proceeds to block 414 in which the valid routing request data is resolved via the CRS application 21 to a predetermined wire-based medium 17, such as the international direct dialing land-line. Next, in block 416, communication is established between the user's wire-based phone 13 or wireless phone 12, and the subscriber's wireless communication device 11 (based on the destination telephone number) via the predetermined wire-based medium 17, as described below and in greater detail in conjunction with FIG. 5B. The flow then proceeds to block 418 in which the overall process ends. In an exemplary embodiment, at least one of the wireless communication devices 11 or 12 is a Global System for Mobile communication (GSM) device.

FIG. 5A further illustrates the authenticating process described in block 412 of FIG. 4. As shown in FIG. 5A, the process begins in block 500 in which the wireless subscriber's account is checked against a predetermined authentication criteria of determining if the wireless subscriber's account is active. In an exemplary embodiment, a predetermined flag is used to determine if the wireless subscriber's account is inactive, such as due to non-payment or user's request. Next, in block 510, the wireless subscriber's account is checked against another predetermined authentication criteria of determining if the wireless subscriber has available communication time, such as available air-time minutes. In an exemplary embodiment, the remote host system is in communication with a memory subsystem 16 from which the wireless subscriber's account information can be retrieved, such as via host system 10. The flow then proceeds to block 520 for returning to block 412 of FIG. 4.

FIG. 5B further illustrates the process described in block 416 of FIG. 4. As shown in FIG. 5B, the process begins in block 530 in which a host system 10 is selected based on the destination telephone number wherein the host system 10 in communication with the remote host system 20 via the wire-based medium 17. In an exemplary embodiment, the host system 10 is host to the CRS application 15 which functions to communicate with the CRS application 21 to establish the communication between the host system 10 and remote host system 20 via the wire-based medium 17. Next, in block 540, the communication between the communication devices 12 or 13 and the destination subscriber's wireless communication device 11 is established based on the destination telephone number via the host system 10, such as by routing the call through wireless network 14. The flow then proceeds to block 550 for returning to block 416 of FIG. 4.

FIG. 5C further illustrates the process described in block 416 of FIG. 4. As shown in FIG. 5C the process begins in block 560 in which a record corresponding to a wireless subscriber's account is maintained, such as a log file of user's activities. Next, in block 570, the record is updated based on the received routing request and established communication to reflect wireless subscriber's currently received call. The flow then proceeds to block 580 for returning to block 416 of FIG. 4.

In an exemplary embodiment, the CRS application 15 provides a web-based interface for remote administration and provisioning, such as for adding and maintaining user accounts. Suitably, subscriber minutes are paid for in advance (prepaid) and subscribers are allowed to purchase additional minutes by calling the CRS application 15 and following the voice prompts to enter their credit card information (if the CRS application 15 does not currently store it), choose the amount of additional minutes to purchase and validate the transaction amount.

One advantage of the foregoing feature of the present invention over the prior art is that by allowing a caller to select a wire-based medium to route a call to a wireless subscriber, a wireless subscriber is provided with the ability to allow callers to select a desired cost-efficient link for routing of the calls received by the wireless subscriber.

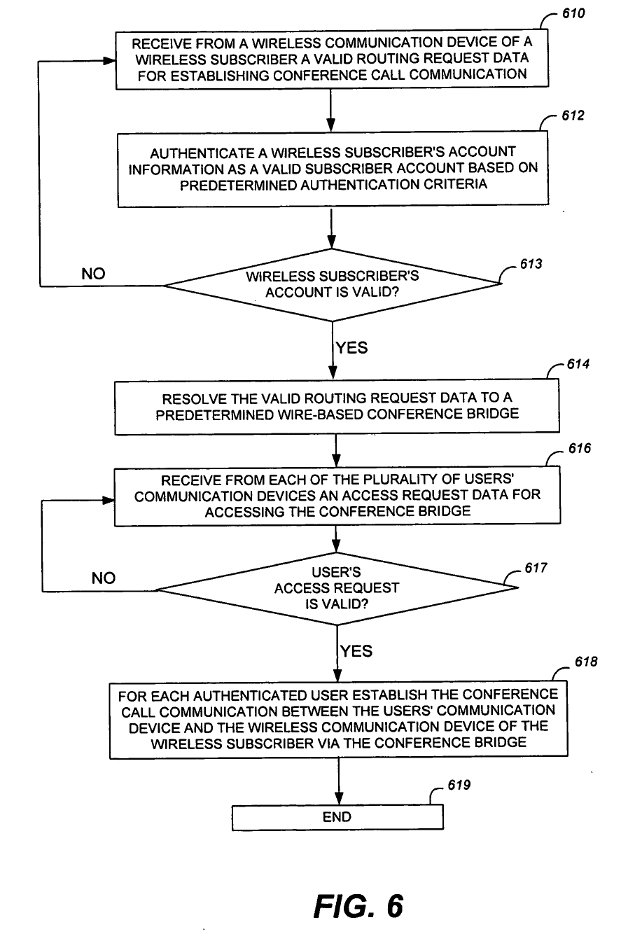

Another embodiment of the present invention is a method for establishing conference call communication between a wireless subscriber 11 and a plurality of users' communication devices, such as wire-based phone 13 and wireless phone 12 as illustrated via the flow diagram in FIG. 6 and in conjunction with FIG. 1. As shown in FIG. 6, the process begins in block 610 in which a valid routing request data is received from a wireless communication device 11 of a wireless subscriber for establishing a conference call communication with the users' communication devices. In an exemplary embodiment, the valid routing request data comprises a predetermined conference hosting code of the wireless subscriber. Next, in block 612, the wireless subscriber's account information is authenticated as a valid subscriber account based on predetermined authentication criteria as described above in conjunction with FIG. 5A. Next, in decision block 613, if it is determined that the wireless subscriber's account is invalid, the process returns to block 610 for receipt of further data. In an exemplary embodiment, the wireless subscriber is notified of the invalid status of the wireless subscriber's account and prompted to re-enter a valid account. If in decision block 613 it is determined that the wireless subscriber's account is valid, then the flow proceeds to block 614 in which the valid routing request data is resolved to a predetermined wire-based conference bridge, such as a conference bridge utilizing wire-based medium 17. Next, in block 616, an access request data is received from each of the users' communication devices, such as wire-based phone 13 and wireless phone 12, for accessing the wireless subscriber's conference bridge. In an exemplary embodiment, the access request data comprises a predetermined conference bridge participation code of the wireless subscriber.

Next, in decision block 617, if it is determined that the received access request data is invalid, the process returns to block 616 for receipt of further data. In an exemplary embodiment, the user is notified of the invalid status of the access request data and prompted to a valid access request data. If in decision block 617 it is determined that the user's access request data is valid, then the flow proceeds to block 618 in which for each user with a valid access request data, the conference call communication is established between each users' communication device and the wireless communication device 11 of the wireless subscriber via the conference bridge which utilizes the predetermined wire-based medium 17. The flow then proceeds to block 619 in which the overall process ends. In an exemplary embodiment, at least one of the wireless communication devices 11 or 12 is a Global System for Mobile communication (GSM) device.

As an example to illustrate the foregoing embodiment of the present invention described in FIG. 6, suppose a wireless subscriber A residing in the United States (U.S.) wishes to establish a conference call with users B and C residing in Taiwan and Nepal, respectively. Wireless subscriber A first starts the conferencing by dialing a predetermined dial number such as 1-800-555-1212, then enters his personal conference hosting code, such as 412468. Upon authentication that wireless subscriber A's account is valid, his personal conference hosting code is resolved to a predetermined wire-based conference bridge, and then he waits for the users B and C to join in. User B then dials the local Taiwan bridge, such as by dialing 555-2323, and then enters wireless subscriber A's participation code, such as 512312. Upon authentication that the entered participation code is valid, user B is allowed to join into the conference bridge and establish communication with wireless subscriber A. User C, subsequently to or simultaneously with user B, dials the U.S. toll free bridge, such as at 1-800-555-1212, and then enters wireless subscriber A's participation code, such as 512312. Upon authentication that the entered participation code is valid, user C is allowed to join into the conference bridge and establish communication with wireless subscriber A and user B. All parties are now connected via a conference call using the lower cost wire-based conference bridge and wireless subscriber A's account is charged the lower rate of the wire-based conference bridge.

One advantage of the foregoing feature of the present invention over the prior art is that by allowing a plurality of callers to use a wire-based medium for a conference call to a wireless subscriber, a wireless subscriber is provided with the ability to select a desired cost-efficient link for routing of the conference calls received by the wireless subscriber.

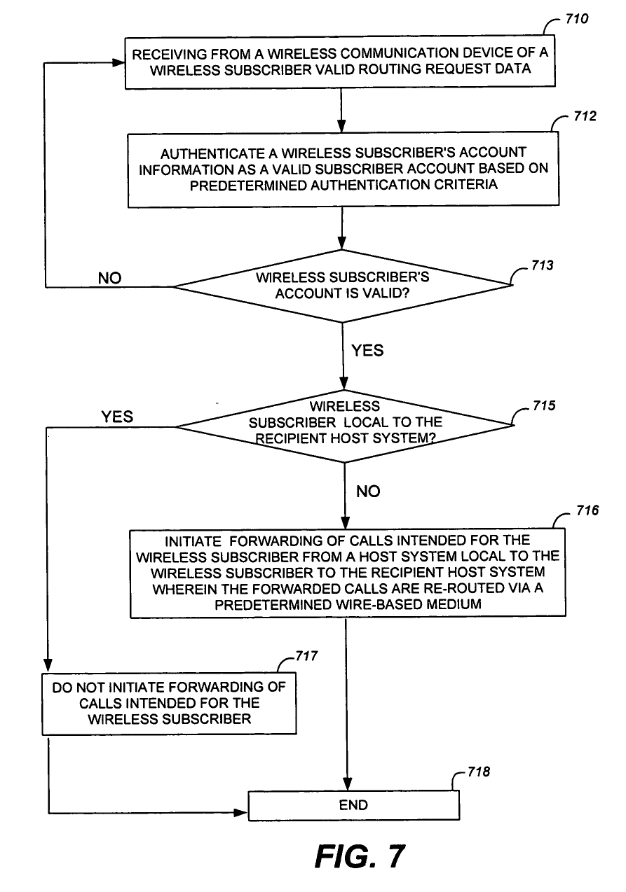

Another embodiment of the present invention is the method for routing communications by a recipient host system to a wireless subscriber as illustrated via the flow diagram in FIG. 7 and in conjunction with FIG. 1. As shown in FIG. 7, the process begins in block 710 in which a wireless subscriber's valid routing request data is received in a recipient host system, such as the remote host system 20, from a wireless communication device 12 of the wireless subscriber. Next in block 712, the wireless subscriber's account information is authenticated as a valid subscriber account based on predetermined authentication criteria, as described above in conjunction with FIG. 5A. Next, in decision block 713, if it is determined that the wireless subscriber's account is invalid, the process returns to block 710 for receipt of further data. In an exemplary embodiment, the user is notified of the invalid status of the wireless subscriber's account and prompted to re-enter a valid account. If in decision block 713 it is determined that the wireless subscriber's account is valid, then the flow proceeds to decision block 715.

In decision block 715 it is determined if the wireless subscriber is local to the recipient host system, such as to remote host system 20, based on predetermined locating criteria, such as roaming determination criteria. If in decision block 715 it is determined that the wireless subscriber is not local to the recipient host system, the flow proceeds to block 716 in which a forwarding of calls intended for the wireless subscriber is initiated from a host system local to the wireless subscriber to the recipient host system wherein the forwarded calls are re-routed via a predetermined wire-based medium. For example if the wireless subscriber's wireless communication device 12 is determined to be local to the host system 10 but is now roaming in the area of host system 20, then the host system 10 forwards the calls intended for to the wireless subscriber to the host system 20 via re-routing the calls through the wire-based medium 17. In an exemplary embodiment, the local host system such as host system 10 is notified by the recipient host system, such as remote host system 20 of the current location of the wireless subscriber for initiating the call forwarding by the host system 10. The flow then proceeds to block 718 in which the overall process ends. If in decision block 715 it is determined that the wireless subscriber is local to the recipient host system, the flow proceeds to block 717 in which the no call forwarding is initiated. The flow then proceeds to block 718 in which the overall process ends.

One advantage of the foregoing feature of the present invention over the prior art is that by forwarding calls intended for the wireless subscriber from a host system local to the wireless subscriber to a recipient host system via a predetermined wire-based medium, the wireless subscriber is provided with the ability to receive forwarded calls via a desired cost-efficient wire-based link.

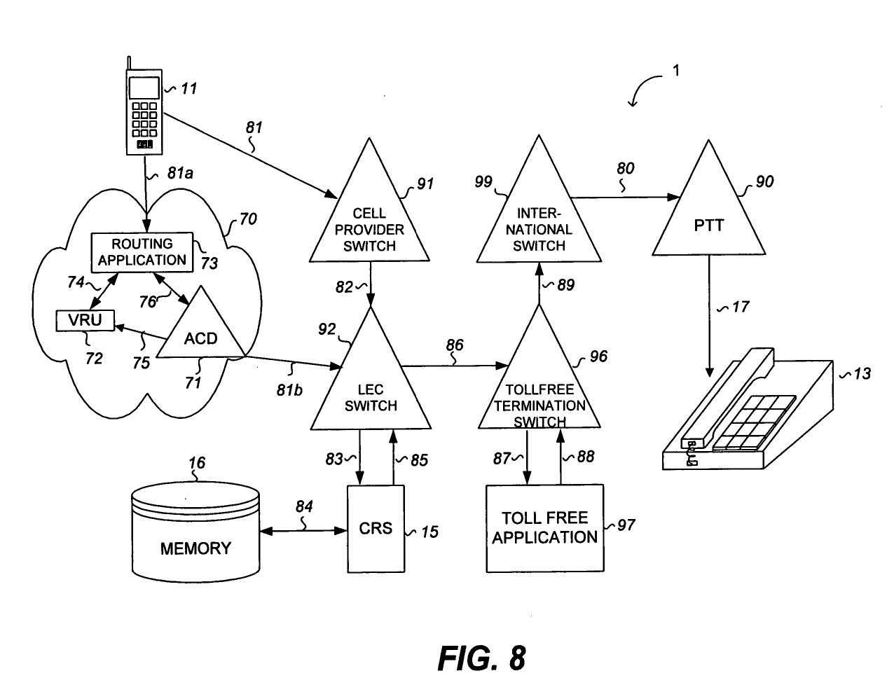

FIG. 8 illustrates in greater detail exemplary aspects of the exemplary communication system 1 shown in FIG. 1. As described below in greater detail, the CRS application 15 will broker calls made from a wireless communication device 11 of a wireless subscribers to destinations directed by the wireless subscriber, such as to destination communication device 13. In an exemplary embodiment, a toll free application 97 is used.

As shown in FIG. 8, in an exemplary embodiment, a wireless subscriber places a call 81 via a wireless communication device 11 to the CRS application 15 using a dedicated local number. In an exemplary embodiment, the call 81 is made using a communication application residing on the wireless communication device 11, such as a Java Calling Card Application (JCCA) as described in the above-referenced patent application. As shown in FIG. 8, the call 81 is routed through a cell provider switch 91 to the local exchange carrier (LEC) 92.

In another exemplary embodiment, a wireless subscriber places a call 81a via a wireless communication device 11 to the CRS application 15 using a calling card application 70. Suitably the calling card application 70 is a a 24×7×365 application driven by a Toll Free number that has “type ahead” features (i.e. ability to read key presses and navigate a Voice Response Unit (VRU) 72 application without prompting the user for digits each step of the way). A typical calling card application 70 is driven by an 800/888/866 prefixed number that is routed to an operator service center 73 or a switch with equivalent intelligent capabilities. The calling party is routed via signaling data 76 into calling card application 70 that is driving an Automatic Call Distributor (ACD) 71, multiple operator stations, and multiple Interactive Voice Response (IVR) or VRU 72 applications. In this embodiment, once the routing application 73 has slotted the call for VRU 72, the voice portion 75 of the call will be sent to the VRU 72 via the ACD 71, and the signaling data 74 about the call will also be sent to the VRU 72 via the routing application 73. The VRU 72 will then “drive” the call by collecting dual tone multi frequency (DTMF) digits, offering menu navigation choices based on those digits, and providing the calling card application 70 with the necessary data to route the call 81b to the destination. In an exemplary embodiment, once the VRU 72 has determined all the necessary info has been collected, the information is passed back to the routing application 73 which will bridge out of the call 81b after releasing the VRU 72 from the call. The call 81b will have effectively been passed to the LEC switch 92 to be routed to the final destination.

In an exemplary embodiment, the present invention includes a Live-Person/Machine-Detection function that allows an application to determine if a machine or a person picked up a call. In this way, while using a calling card application 70, it can be determined if a call was routed to an operator or to a VRU 72. If a recording is detected as answering the call rather than a live person, the DTMF digits can then be pulsed out to navigate the VRU 72 so that the calling card application 70 can route the call to the intended destination.

Once a forwarded call 82 or 81b is received in the LEC 92, the LEC 92 then forwards the routed call to a CRS-enabled private branch exchange (PBX). The CRS application 15 receives the forwarded call 83 and then validates calls by communicating with the memory subsystem 16 which contains authenticating and routing information, and provides the digits for out pulsing calling card application number. In an exemplary embodiment, the CRS application 15 receives the forwarded call 83 based on receiving DTMF digits from the wireless subscriber's JCCA.

Next, the CRS application 15 transmits International Toll Free Application Number via pulses 85 and waits for pickup on line, such as by using Live Speaker Recognition Feature. The CRS application 15 is now in an active listening mode so it can out pulse DTMF digits to calling card application. Next, the LEC switch 92 passes the call to destination Toll Free Termination Switch (TFTS) 96 which then passes the call to the Toll Free Application (TFA) 97 which receives the call 87 and listens for DTMF digits. The CRS application 15 detects that a machine answered the call and out pulses DTMF digits to the TFA 97. The TFA 97 detects the out pulsed DTMF digits and interrogates the call 87 for necessary information. The TFA 97 then dials the international number via signal 88 and hands the call off to the TFTS 96. The TFA 97 listens for answer on the called party number. Next, the TFTS 96 forwards the call to an international switch 99 which passes the forwarded call 89 to the Push to Talk (PTT) 90 switch, such as another international switch. The PTT 90 then receives the forwarded call 80 and effectuates the connecting of the wireless subscriber to destinations directed by the wireless subscriber, such as to destination communication device 13, using wire-based medium 17 as described in FIG. 1. In an exemplary embodiment, the TFA 97 then determines how to conduct operations to manage the answer of the call using techniques well known in the art.

In an exemplary embodiment, the CRS application 15 is built on a Linux operating system platform, suitably on a Linux version 2.4 or later, and implemented in C++ programming language. Suitably, any other interfaces to the system 1 are at the discretion of the user of the system 1. In an exemplary embodiment, the CRS application 15 will be abstracted from an actual implementation, suitably relying on a Common Object Request Broker Architecture (CORBA) which allows for separating the implementation details from the business details, and for modular upgrading as technologies change. Suitably, the CRS application 15 implementation comprises an active and available fully supported Object Request Broker (ORB), running 2.6 compliant software. Suitably, the naming service will reside locally to reduce potential problems with communications. In an exemplary embodiment, persistence mechanisms use MySQL version 3.23.58 or later. In an exemplary embodiment, call control mechanisms comprise an ACULAB T1 card having a driver set wrapped with a C-based application programming interface (API). In an exemplary embodiment, built in layers of abstraction are used to enable call control to be mixed and matched between hardware vendors provided that the basic DTMF for inbound and outbound calls is supported.

In another exemplary embodiment, the CRS application 15 is implemented in a direct access configuration wherein the CRS application 15 acts as an operator services platform and answers inbound calls. Validation is performed by the CRS application 15 and then the call is routed to the destination directly through international switches. The CRS application 15 then bridges out of the call thus freeing up resources to handle more validation volume.

FIG. 9 illustrates an exemplary hierarchical implementations of the CRS application 15. As shown in FIG. 9, an exemplary CRS application 15 comprises three distinct areas of responsibility: 1) Core Call Management (CCM) 15a, 2) Call Controller Interface (CCI) 15g comprising interfaces: a) Port Control 15b, b) Inbound Call Management 15c, c) Outbound Call Management 15d; and 3) Logging and Validation 15e. Suitably, a CORBA abstraction layer 15f is utilized in conjunction with the above implementation to facilitate additions of other areas of responsibility based on a desired need for a particular implementation. Each of the above areas of responsibility will now be discussed in greater detail:

1) Core Call Manager 15a: The CCM 15a is an event driven process which relies on triggers or events for determining when an event has happened and when to take appropriate action in response to the event. In an exemplary embodiment, the CCM 15a has multiple interfaces at its disposal, to help drive call progress and to manage the call as a whole. Suitably, the CCM 15a will cache all information other than validation and logging information. In an exemplary embodiment, the CCM 15a will implement and support a Notification Interface as described below. This notification interface triggers the CCM 15a to perform the above-described routing operations of the CRS application 15. In an exemplary embodiment, the CCM 15a will use the CCI 15g to manage a call once a notification is received. The CCM 15a will use the logging and validation interface 15e, with validation used to authorize proceeding with the rest of the call, and the logging used to record details about the call events that occur.

In an exemplary embodiment, messaging will be asynchronous. The CCM 15a will be a single instance, multithreaded application with the ability to manage multiple ports, such as 23 ports, comprising of inbound and outbound calls. Suitably, each instance of the CCM 15a will have and associated inbound call manager, outbound call manager, validation mechanism, and logging mechanism. In an exemplary embodiment, the notification interface is used for notification that a call is pending or that some action has occurred during call connection either inbound or outbound. These notification functions include: 1a) Status indication, 1b) Inbound call connection indication, 1c) Inbound call disconnected indication, 1d) Outbound call connection indication, and 1e) Outbound call disconnected indication, as described below:

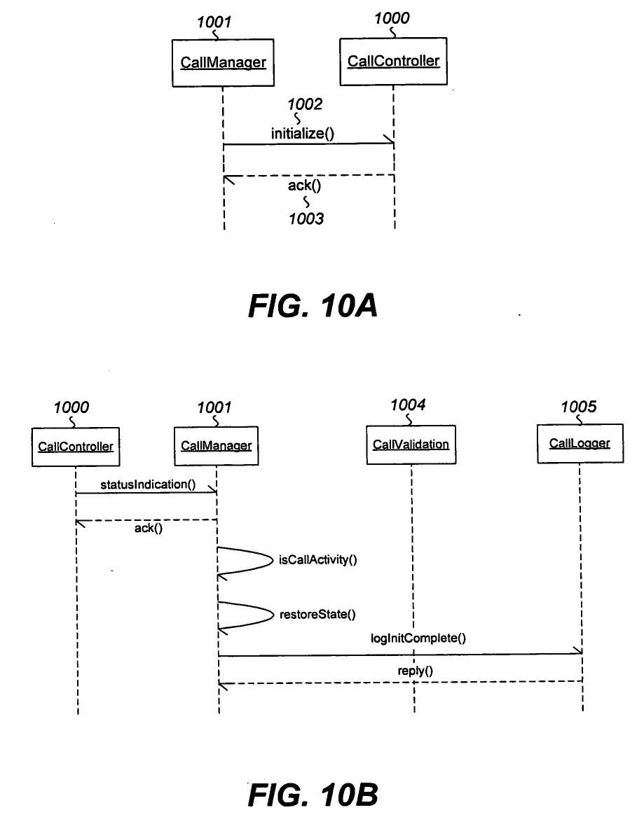

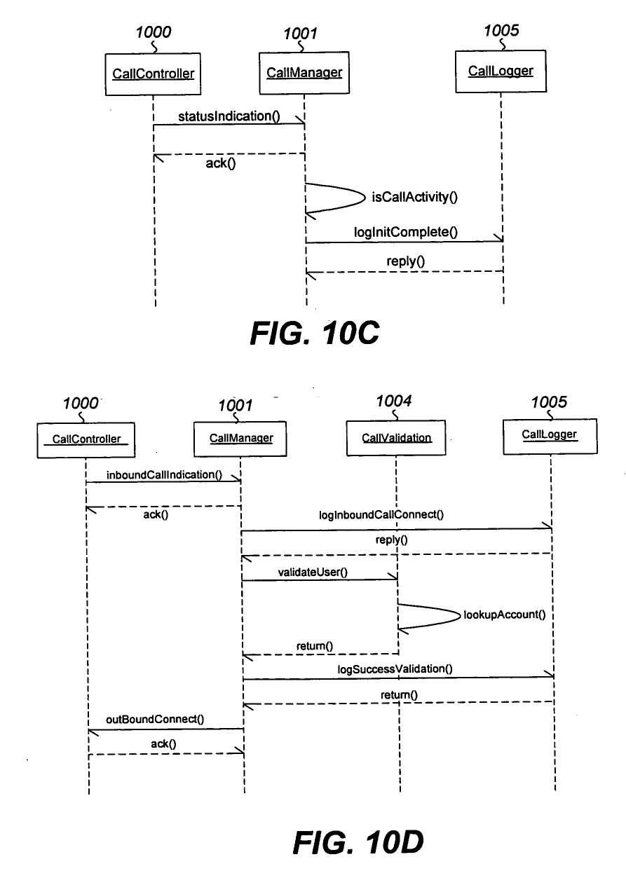

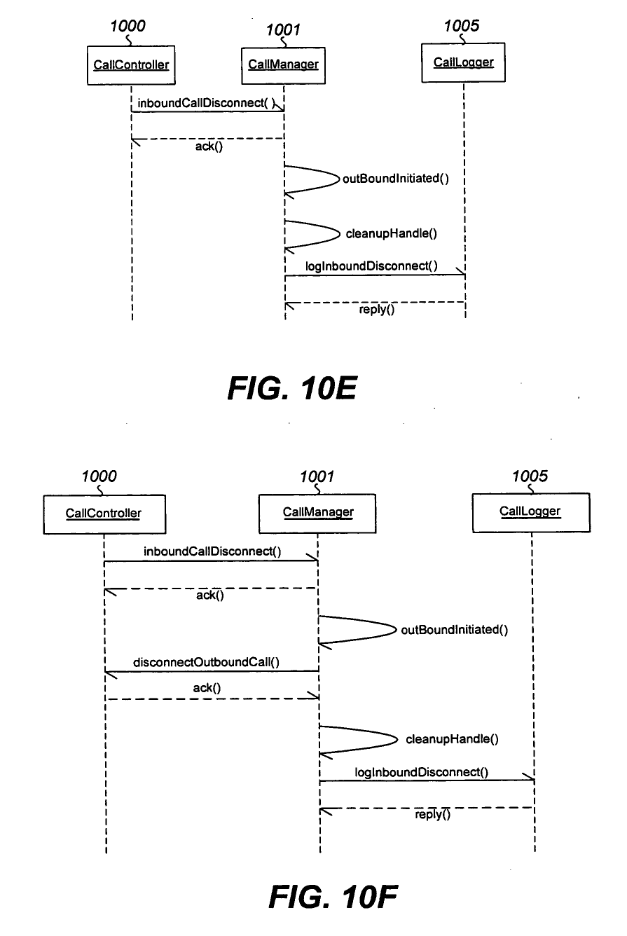

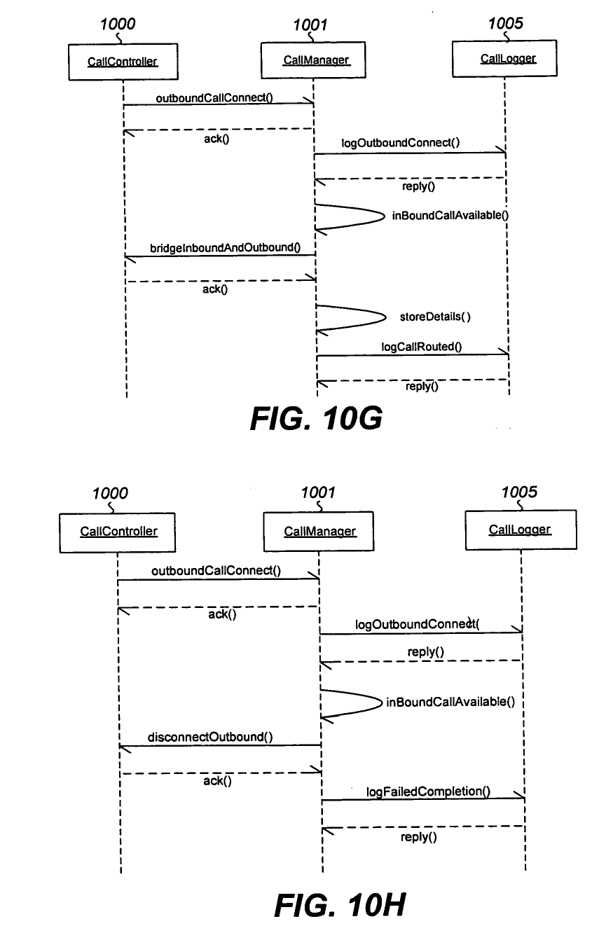

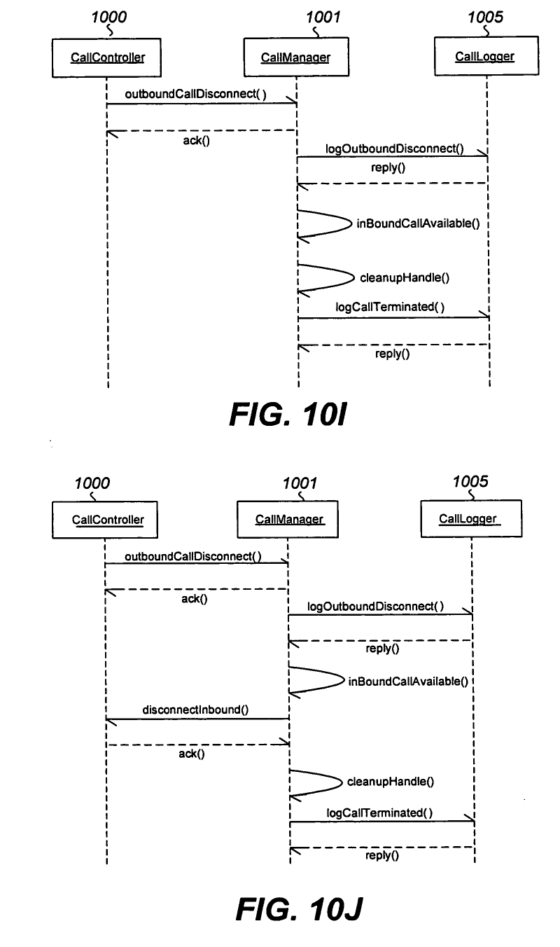

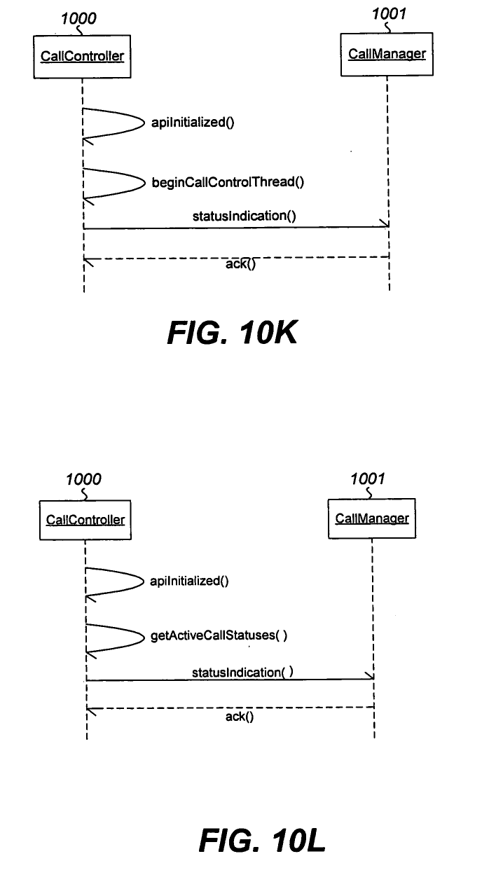

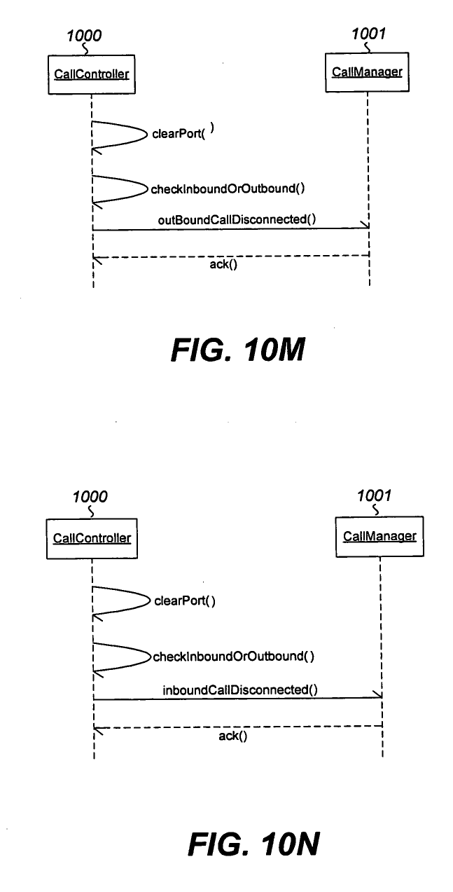

1a) Status indication: Upon startup, such as during initialization, it is generally unclear what state any hardware interface will be in, thus the CCM 15a will attempt to establish a known state. In an exemplary embodiment, the CCM 15a will invoke an interface, such as a CallController's 1000 initialize( ) 1002 interface shown in the sequence diagram of FIG. 10A below, managed by CCI 15g to establish that known point. Since it is possible that calls could be in progress at the point of initialization, the CCM 15a expects CallController's 1000 initialize( ) 1002 to return a sequence of handles for calls that are currently active at the time of initialization. This sequence will be used to query a table managed by Logging and Validation 15e. Logging and Validation 15e will look up the information about each handle to help re-establish the original state of the CCM 15a if it was downed in the middle of call management. As shown in FIG. 10A, since the method to CallController 1000 (i.e. CCI 15g) is asynchronous, the “ack” 1003 will come back in the reply. The CCI 15g will thread out the initialization allowing the CORBA call to complete back to CallManager 1001 (i.e. CCM 15a).

As shown in the sequence diagram of FIG. 10B, initialization may also take place during active calls with the help of CallValidation 1004 and CallLogger 1005 which respectively validate a customer connecting to the network to use the services, and log calls such as information regarding the calls, such as caller's telephone number, callers' SIM ID, recipient's telephone number, recipient's SIM ID, duration of call, and optionally routing information as described below and in greater detail. In this exemplary embodiment, the CCM 15a is able to re-establish where it left off should it be brought down during processing. Suitably, the CCI 15g will have been triggered, upon the CCM 15a startup via initialization, to send a status indication to the CCM 15a.

As shown in the sequence diagram of FIG. 10C, normal initialization may also occur when no calls are present and the target platforms API is not initialized. FIG. 10C illustrates the actions taken during this process.

1b) Inbound call connection indication: When an inbound call connection indication is received, it indicates that the CCI 15g has accepted a call and has parsed all inbound DTMF digits necessary for the CCM 15a to determine if this call is valid as illustrated in the sequence diagram of FIG. 10D. The CCM 15a will receive a new handle for the call, the account number information (ANI), the caller account number (CAN), a personal identification number (PIN), and the called party number. The CCM 15a will use this data to determine if the call can progress. Logging and Validation 15e will be used to manage the validation activity. The CAN will be used by call validation feature of Logging and Validation 15e to find the preferred IDD calling card service toll free number and the calling card number that was setup upon account initialization. These numbers will be used to establish an outbound call through the CCI 15g.

1c) Inbound call disconnected indication: An inbound call disconnected message could be received during the actual call or during call cleanup. If received during the call, it could mean the calling party terminated the call or the connection was lost. Suitably, everything associated with this call will need to be cleaned up. If the disconnect occurs after the CCM 15a has initiated a disconnect request, the call is merely being cleaned up. Suitably, the CCM 15a deals with all calls by their handle. This handle is used for tying inbound and outbound calls together and looking up states of a call for proper call handling. Sequence diagram of FIG. 10E illustrates a disconnect sequence for call cleanup scenario when cleaning up internal information about the calling party (inbound call).

Sequence diagram of FIG. 10F illustrates a scenario when a disconnect is received during call activity from the calling party. In this scenario the called party (outbound call) is disconnected and clean up all call details in the CCM 15a.

1d) Outbound call connection indication: When an outbound call connection indication is received, it will have been due to an initiation on the CCM 15a side to do so via the CCI 15g. Suitably, the CCI 15g performs the necessary tasks and signals the CCM 15a that it has successfully dialed an outbound call and made the connection to the called party. During the processing of this activity, two sates are possible: 1) the calling party is on the line, as illustrated in the sequence diagram of FIG. 10G, and 2) the calling party hung up, as illustrated by the sequence diagram of FIG. 10H.

1e) Outbound call disconnected indication: When this event is triggered, the outbound call has been disconnected either by the will of the CCM 15a or by the called party hanging up the phone. The CCM 15a will then need to clean up the call and to make sure that the inbound call is not active, as illustrated by the sequence diagram of FIG. 10I. If the inbound call is active, the CCM 15a will need to force disconnect the call, as illustrated by the sequence diagram of FIG. 10J.

2) Call Controller Interface (CCI) 15g: The CCI 15g will manage the activities on the ports and connecting calls once notifications for those calls have arrived. Suitably, the CCI 15g is an event driven process which relies on triggers from the target environments API and from the CCM 15a to perform its tasks. As shown in FIG. 9, the CCI 15g comprises three interfaces: 2a) Port Control 15b, 2b) Inbound Call Management 15c, 2c) Outbound Call Management 15d, as described below:

2a) Port Control 15b: The Port control 15b is an interface by which ports can be initialized, queried for information, and connect with other ports to bridge calls. Suitably, the Port control 15b is coupled with the driver set of a desired implementation. In an exemplary embodiment, the port control 15b will be used to initialize the Inbound Call Management 15c and the Outbound Call Management 15d once the CCM 15a is ready to accept call activity. The port control 15b can also be used to reset or clear calls that may be hanging. In an exemplary embodiment, the port control 15b supports the following functions: i) Initialize, ii) Clear Port(s) and Bridge Port(s) (Connect Inbound with Outbound Call), as described below in greater detail:

i) Initialize: Initialize will check all ports and see if calls are active on them if initialization had previously occurred. It is possible for the CCM 15a to not be available should a critical system error occur, yet have the CCI 15g still managing calls. If the API has not been initialized, the CCI 15g will go through initializing the API and then it will wait for a call, as illustrated by the sequence diagram of FIG. 10K. If the API has already been initialized and the call activity is present, the CCI 15g will send as much information as possible about all active calls to the CCM 15a and proceed on, as illustrated by the sequence diagram of FIG. 10L.

ii) Clear Port(s) and Bridge Ports: This functionality will be used when disconnecting a call or when resetting the system with the goal of freeing the resources for a given call or set of calls. Clearing multiple ports involves looping through the desired ports and clearing them. The sequence diagram of FIG. 10M illustrates an exemplary process for clearing port(s) for an outbound call. The sequence diagram of FIG. 10N illustrates an exemplary process for clearing port(s) for an inbound call:

2b) Inbound Call Management 15c: The Inbound Call Management 15c is an interface dealing with activities associated with inbound calls, such as disconnecting, disconnecting with announcement, and stop ring tone functions. Suitably, the Inbound Call Management 15c is coupled with the driver set of a desired implementation.

2c) Outbound Call Management 15d: The Outbound Call Management 15d is an interface dealing with activities associated with outbound calls, such as connecting and disconnecting of outbound calls functions. Suitably, the Outbound Call Management 15d is coupled with the driver set of a desired implementation.

3) Logging and Validation 15e: The Logging and validation 15e is an interface that handles two areas of responsibility. The first responsibility is validation of a customer connecting to the network to use the services. The second responsibility is logging call events. These events can comprise of basic information such as connection received on a port for an inbound call to failed validation attempts. The logging interface will be responsible for storing information about a call during call progress. This can eventually be used to create a CDR for the call or track attempts that may be fraudulent. Functions supported by this interface are may include: Log Inbound Connect, Log Inbound Disconnect, Log Outbound Connect, Log Outbound Disconnect, Log Failed Validation, Log Success Validation, and Log Initialization Complete.

It should be noted that the various features of the foregoing embodiments were discussed separately for clarity of description only and they can be incorporated in whole or in part into a single embodiment of the invention having all or some of these features.

What is claimed is:

1. A method for routing wireless communications by a host system, the method comprising:
receiving from a wireless communication device of a wireless subscriber a valid routing request data;
authenticating a wireless subscriber's account information as a valid subscriber account based on predetermined authentication criteria, and if the account information is valid:
receiving from the wireless communication device a destination telephone number of a destination communication device;
resolving the valid routing request data to a predetermined wire-based medium; and
establishing communication between the subscriber's wireless communication device and the destination communication device via the predetermined wire-based medium based on the destination telephone number.

2. The method as defined in claim 1, the establishing further comprising:
selecting a remote system based on the destination telephone number, the remote system in communication with the host system via the wire-based medium; and
establishing communication between the subscriber's wireless communication device and the destination communication device via the remote system.

3. The method as defined in claim 1, the authenticating further comprising:
receiving a user-identification data from the wireless communication device; and
retrieving the account information corresponding to the subscriber based on the received user-identification data.

4. The method as defined in claim 3, wherein the user-identification data comprises a caller-identification data.

5. The method as defined in claim 3, wherein the user-identification data comprises an equipment-identification data corresponding to the wireless communication device of the wireless subscriber.

6. The method as defined in claim 3, the predetermined authentication criteria comprising:
determining if the wireless subscriber has available communication time.

7. The method as defined in claim 3, the predetermined authentication criteria comprising:
determining if the wireless subscriber's account is active.

8. The method as defined in claim 1, further comprising:
maintaining a record corresponding to a wireless subscriber's account; and
updating the record based on at least one of a received routing request and established communication.

9. The method as defined in claim 1, wherein the destination communication device is at least one of a wireless and wire-based communication device.

10. The method as defined in claim 1, wherein the routing request data comprises a data string comprising at least one of character and numeric data.

11. The method as defined in claim 1, wherein the wireless communication device comprises a Global System for Mobile communication (GSM) device.

12. A method for routing communications by a host system to a wireless subscriber, the method comprising:
receiving from a user's communication device a valid routing request data and a destination telephone number of a wireless communication device of a wireless subscriber;
authenticating a wireless subscriber's account as a valid subscriber's account based on the received destination telephone number and predetermined authentication criteria, and if the wireless subscriber's account is valid:
resolving the valid routing request data to a predetermined wire-based medium; and
establishing communication between the user's communication device and the subscriber's wireless communication device via the predetermined wire-based medium.

13. The method as defined in claim 12, the establishing further comprising:
selecting a remote system based on the destination telephone number, the remote system in communication with the host system via the wire-based medium; and
establishing communication between the user's communication device and the subscriber's wireless communication device via the remote system.

14. The method as defined in claim 12, wherein the predetermined authentication criteria comprising:
determining if the wireless subscriber has available communication time.

15. The method as defined in claim 12, wherein the predetermined authentication criteria comprising:
determining if the wireless subscriber's account is active.

16. The method as defined in claim 12, further comprising:
maintaining a record corresponding to a wireless subscriber's account; and
updating the record based on at least one of a received routing request and established communication.

17. The method as defined in claim 12, wherein the destination communication device is a wireless communication device.

18. The method as defined in claim 12, wherein the user's communication device is at least one of a wire-based and wire-based communication device.

19. The method as defined in claim 12, wherein the wireless communication device comprises a Global System for Mobile communication (GSM) device.

20. The method as defined in claim 12, wherein the routing request data comprises a data string comprising at least one of a character and numeric data.

21. A method for establishing conference call communication between a wireless subscriber and a plurality of users' communication devices, the method comprising:
receiving from a wireless communication device of a wireless subscriber a valid routing request data for establishing conference call communication; and
authenticating a wireless subscriber's account information as a valid subscriber account based on predetermined authentication criteria, and if the account information is valid:
resolving the valid routing request data to a predetermined wire-based conference bridge;
receiving from each of the plurality of users' communication devices an access request data for accessing the wireless subscriber's conference bridge;
authenticating each user's access request data, and if the access request data is valid:
establishing for each authenticated user the conference call communication between each users' communication device and the wireless communication device of the wireless subscriber via the conference bridge.

22. The method as defined in claim 21, wherein the valid routing request data comprises a predetermined conference hosting code of the wireless subscriber.

23. The method as defined in claim 21, wherein the access request data comprises a predetermined participation code of the wireless subscriber.

24. A method for routing communications by a recipient host system to a wireless subscriber, the method comprising:
receiving from a wireless communication device of a wireless subscriber a valid routing request data; and
authenticating a wireless subscriber's account information as a valid subscriber account based on predetermined authentication criteria, and if the account information is valid:
determining if the wireless subscriber is local to the recipient host system based on predetermined locating criteria, and if the wireless subscriber is not local to the recipient host system:
initiating a forwarding of calls intended for the wireless subscriber from a host system local to the wireless subscriber to the recipient host system wherein the forwarded calls are re-routed via a predetermined wire-based medium.

25. The method as defined in claim 24, the initiating further comprising:
notifying the local host system by the recipient host system of a current location of the wireless subscriber.

26. A host system for routing wireless communications, the host system comprising:
a receiver subsystem in communication with a wireless communication device of a wireless subscriber and adapted to receive from the wireless communication device a valid routing request data and a destination telephone number of a destination communication device;
an authentication subsystem adapted to authenticate a wireless subscriber's account information as a valid subscriber account based on predetermined authentication criteria;
a resolution subsystem adapted to resolve the valid routing request data to a predetermined wire-based medium if the account information is valid; and
a routing application residing in the host system and adapted to establish communication between the subscriber's wireless communication device and the destination communication device via the predetermined wire-based medium based on the destination telephone number.

27. The host system as defined in claim 26, wherein the routing application is adapted to select a remote system based on the destination telephone number, the remote system in communication with the host system via the wire-based medium, and to establish communication between the subscriber's wireless communication device and the destination communication device via the remote system.

28. The host system as defined in claim 26, wherein the authentication subsystem is in communication with a memory subsystem, the authentication subsystem adapted to retrieve the account information corresponding to the subscriber from the memory subsystem based on user-identification data received from the wireless communication device in the receiver subsystem.

29. The host system as defined in claim 26, wherein the memory subsystem comprises updateable data corresponding to at least one of an available communication time of a wireless subscriber, an active status of the wireless subscriber's account, and a record corresponding to a wireless subscriber's account, wherein the predetermined criteria is based on the updateable data.

30. The host system as defined in claim 26, further comprising:
wherein the receiver subsystem is in communication with a user's communication device and further adapted to receive from the user's communication device the valid routing request data and a destination telephone number of a wireless communication device of the wireless subscriber;
wherein the authentication subsystem is further adapted to authenticate the wireless subscriber's account as a valid subscriber's account based on the received destination telephone number of the wireless communication device and predetermined authentication criteria;
wherein the resolution subsystem is further adapted to resolve the valid routing request data to the predetermined wire-based medium if the account information is valid; and
wherein the a routing application is further adapted to establish communication between the user's communication device and the subscriber's wireless communication device via the predetermined wire-based medium.

31. The host system as defined in claim 26, further comprising:
a call forwarding subsystem adapted to determine if the wireless subscriber is local to the host system based on predetermined locating criteria, and if the wireless subscriber is not local to the host system to initiate a forwarding of calls intended for the wireless subscriber from a remote system local to the wireless subscriber to the host system wherein the forwarded calls are re-routed via the predetermined wire-based medium.

32. The host system as defined in claim 26, wherein the call forwarding subsystem is further adapted to notifying the remote system of a current location of the wireless subscriber.

33. The host system as defined in claim 26, further comprising:
wherein the receiver subsystem is further adapted to receive from a wireless communication device of a wireless subscriber a valid routing request data for establishing conference call communication between the wireless subscriber and a plurality of users' communication devices, and to receive from each of the plurality of users' communication devices an access request data for accessing a wireless subscriber's conference bridge;
wherein the authentication subsystem is further adapted to authenticate the wireless subscriber's account information as a valid subscriber account based on predetermined authentication criteria, and to authenticate each user's access request data as a valid access request data,
wherein the resolution subsystem is further adapted to resolve the valid routing request data for establishing conference call communication to a predetermined wire-based conference bridge if the account information is valid; and
a bridge-conferencing subsystem adapted to establish a conference call communication via the conference bridge between the wireless communication device of the wireless subscriber and each users' communication device having a valid access request data.

34. The host system as defined in claim 33, wherein the valid routing request data comprises a predetermined conference hosting code of the wireless subscriber and wherein the wherein the access request data comprises a predetermined participation code of the wireless subscriber.

35. The method as defined in claim 26, wherein the destination communication device comprises at least one of a wireless and wire-based communication device and wherein the wireless communication device comprises a Global System for Mobile communication (GSM) device.
